(19) United States
(12) Patent Application Publication
(10) Pub. No.: US 2006/0232501 A1
(43) Pub. Date: Oct. 19, 2006

(54) Method and apparatus for implementing a pulse skip method of controlling light intensity

(76) Inventor: William Weiss, Boca Raton, FL (US)

Correspondence Address: TANGENT LAW GROUP, 1201 PENNSYLVANIA AVE, NW, SUITE 300, WASHINGTON, DC, 20004, US

(21) Appl. No.: 11/288,326

(22) Filed: Nov. 29, 2005

Related U.S. Application Data
(60) Provisional application No. 60/631,818, filed on Nov. 29, 2004.

(51) Int. Cl. G09G 3/14

(52) U.S. Cl. 345/46

(57) ABSTRACT

A method and an apparatus for modulating light emitted by an at least one LEDs using a pulse skip modulation technique (PSM). The apparatus having an at least one first LED adapted to output at least first radiation having a first spectrum, an at least one second LED adapted to output second radiation having a second spectrum different than the first spectrum, and at least one controller coupled to the at least one first LED and the at least one second LED and configured to communicate with an at least one controller, the at least one controller further configured to independently control at least a first intensity of the first radiation and a second intensity of the second radiation, wherein the at least one controller is configured to implement a pulse skip modulation (PSM) technique to control at least the first intensity of the first radiation and the second intensity of the second radiation.

### CROSS REFERENCE TO RELATED APPLICATIONS

This application claims benefit of the earlier filed U.S. Provisional Application No. 60/631,818 filed Nov. 29, 2004, which is incorporated herein by reference.

### FIELD OF THE INVENTION

The systems and methods described herein relate to LED systems capable of generating light, such as for illumination or display purposes. The light-emitting LEDs may be controlled by a processor to alter the brightness and/or color of the generated light by using pulse-skip modulated (PSM) signals. The PSM technique for modulating frequency in an electrical signal produces a fade in and fade out effect. In a lighting source, such as an LED or incandescent bulb, by adding or skipping fixed width pulses in a digital environment utilizing a microcontroller. Thus, the resulting illumination may be controlled by a computer program to provide complex, predesigned patterns of light in virtually any environment.

### BACKGROUND OF THE INVENTION

Heretofore known techniques of modulating signals to LEDs have typically utilized a pulse width modulation control technique. The pulse skip technique provides quicker reaction from the controller and numerous other heretofore unknown advantages over these previous techniques. There exists a need to provide a manner by which LEDs lighting systems can be dimmed and colors changed and/or faded in and out with a pulse skip modulation technique for quicker response times and to achive other advantageous properties.

### SUMMARY OF THE INVENTION

An object of the invention is to provide a method of modulating the intensity of an at least one LED light source operating in an at least one light spectrum so as to provide finite control of intensity.

A further object of the invention is to provide a method modulating the color spectrum and/or the intensity of the at least one LED light source.

Yet another object of the invention is to provide an apparatus utilizing a multiple of LEDs in an array and varying the intensity and/or color of the array using a pulse skip modulation technique.

The invention includes an article of manufacture, an apparatus, a method for making the article, and a method for using the article.

The method of the invention includes, in an illumination apparatus having an at least one first LED adapted to output an at least first radiation having a first spectrum, an illumination control method, comprising the method steps of independently controlling at least a first intensity of the first radiation in using a pulse skip modulation (PSM) technique to control the at least the first intensity of the first radiation.

The apparatus of the invention includes an illumination apparatus having an at least one first LED adapted to output at least first radiation having a first spectrum; an at least one second LED adapted to output second radiation having a second spectrum different than the first spectrum; and at least one controller coupled to the at least one first LED and the at least one second LED and configured to communicate with an at least one controller, the at least one controller further configured to independently control at least a first intensity of the first radiation and a second intensity of the second radiation, wherein the at least one controller is configured to implement a pulse skip modulation (PSM) technique to control at least the first intensity of the first radiation and the second intensity of the second radiation.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIGS. 1A-1C illustrates the pulse skip modulation technique of the instant invention in an embodiment varying intensity.

### DETAILED DESCRIPTION OF THE INVENTION

The instant invention it directed generally to a method and a corresponding apparatus having light emitting from at least one light emitting diode (LED). The apparatus utilizes a controller, preferably in a digital environment, whereby the controller utilizes a pulse skip modulation (PSM) technique to vary at least one of the intensity of the light and the spectrum of the light.

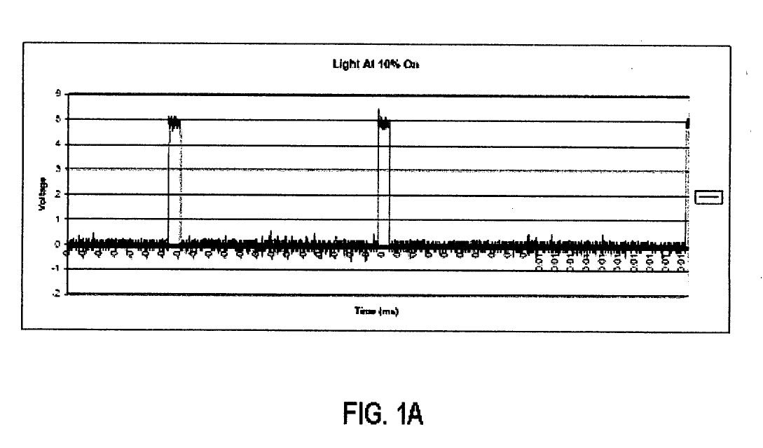

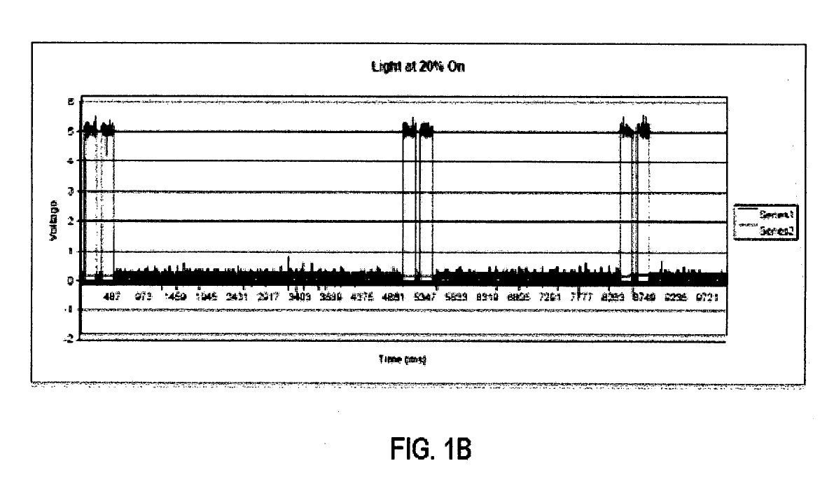

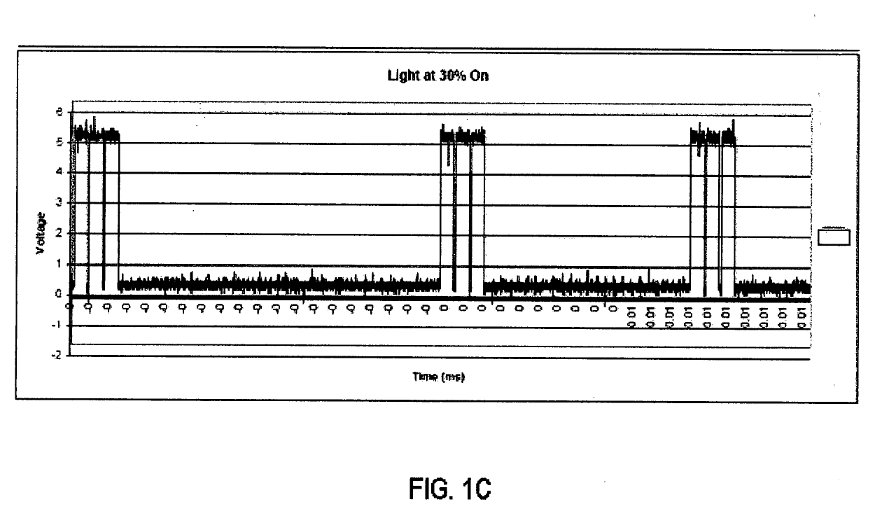

FIGS. 1A-1C illustrates the pulse skip modulation technique of the instant invention in an embodiment varying intensity. Pulses with a constant Pulse Width (PW) are added or subtracted to a fixed Transition Time (TT) at a Transition Rate (TR). This produces a variation of frequency directly proportional to the Positive Duty Cycle (PDC), accelerated by the transition rate (TR) up to a precisely selected Number of Pulses (NP).

In an exemplary embodiment of the method the Pulse width (PW) is selected to be about ten times the minimum transition time (MTT) capable by the controller. This results in a Positive Duty Cycle greater than 90%. This can be expressed mathematically as:
PW=>10×MT

Similarly, in an exemplary embodiment of the instant invention, the Transition Time (TT): Is about 100 times greater than the pulse width (PW) to achieve A Negative Duty Cycle (NDC) under 5%.
TT=>100×PW

An Off time (OT) equal to the transition time (TT) minus the number of Pulses (NP) times the Pulse Width (PW) plus the Minimum Transition Time (MT) divided by the Number of Pulses is a further variable.
OT=(TT−NP×(PW+MT))/NP

A Max NP or maximum number of pulses equal to the Transition Time (TT) divided by the Pulse width (PW) plus the minimum transition time (MT) is provided, as noted by
Max NP=TT/(PW+MT)
with Minimum Frequency (MIF) which is the inverse of the Transition time MIT=1/TT and Maximum Frequency (MXF) which is s inverse of the Pulse Width (PW) plus the Off time (OT) with Max NP.
MXF=1/(PW+((TT−Max NP×(PW+MT))/Max NP)

The Transition Rate (TR) is Max NP minus NP times a constant K (where it is less than or Equal to Max NP K).
TR=Max NP−(NP×K) where NP<=MaxNP/K

The technique is implemented by a controller which is coupled to and communicates with the at least one LED to provide a power signal that is modulated to provide variations in intensity and/or light spectrum issuing from the LED according the method. The method can be utilized with any apparatus that has an at least one LED light source. The method can be utilized to provide multiple color effects as well as effects varying the apparent intensity of the LED or LEDs.

The embodiments and examples discussed herein are non-limiting examples or exemplary embodiments. The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An illumination apparatus, comprising: an at least one first LED adapted to output at least a first radiation having a first spectrum; an at least one second LED adapted to output a second radiation having a second spectrum different than said first spectrum; and at least one controller coupled to the at least one first LED and the at least one second LED and configured to communicate with an at least one controller, the at least one controller further configured to independently control at least a first intensity of the first radiation and a second intensity of the second radiation, wherein the at least one controller is configured to implement a pulse skip modulation (PSM) technique to control at least the first intensity of the first radiation and the second intensity of the second radiation.

2. The illumination apparatus of claim 1, wherein the controller implements the pulse skip modulation technique using a pulses with a constant Pulse Width (PW) added or subtracted to a fixed Transition Time (TT) at a Transition Rate (TR) to produce variations of frequency directly proportional to the Positive Duty Cycle (PDC), accelerated by the transition rate (TR) up to a precisely selected Number of Pulses (NP).

3. The illumination apparatus of claim 2, wherein the controller implements the specific transition time (TT) and a minimum transition time (MTT) and the Pulse width (PW) is about ten times the MTT of the controller.

4. The illumination apparatus of claim 3, wherein the controller implements the PSM technique by further providing an Off time (OT), the off time being equal to the transition time (TT) of the controller minus the Number of Pulses (NP) times the Pulse Width (PW) plus the Minimum Transition Time (MTT) divided by the Number of Pulses (NP).

5. The illumination apparatus of claim 4, wherein the PSM technique implemented by the controller further comprises a maximum number of pulses (Max NP) set as being equal to the, Transition Time (TT) divided by the Pulse width (PW) plus the minimum transition time (MT).

6. The illumination apparatus of claim 5, wherein the PSM technique implemented by the controller further comprises a Minimum Frequency (MIF) which is the inverse of the Transition time (TT) and a Maximum Frequency (MXF) which is s inverse of the Pulse Width (PW) plus the result of the Off time (OT) divided by the maximum number of pulses (Max NP).

7. In an illumination control method, comprising the method steps of independently controlling at least a first intensity of the first radiation of an LED using a pulse skip modulation (PSM) technique to control the at least the first intensity of the first radiation.

8. The an illumination control method of claim 7, wherein the method further comprises the method step of varying the at least a first intensity of the first radiation of an LED using a constant Pulse Width (PW) added or subtracted to a fixed Transition Time (TT) at a Transition Rate (TR) to produce variations of frequency directly proportional to a Positive Duty Cycle (PDC), accelerated by the transition rate (TR) up to a precisely selected Number of Pulses (NP).

9. The illumination control method of claim 8, wherein the method further comprises a specific transition time (TT) and a minimum transition time (MTT) based on a controller and the Pulse width (PW) is about ten times the MTT of the controller.

10. The illumination control method of claim 9, further comprising the steps of proving an Off time (OT), the off time being equal to the transition time (TT) of the controller minus the Number of Pulses (NP) times the Pulse Width (PW) plus the Minimum Transition Time (MTT) divided by the Number of Pulses (NP).

11. The illumination control method of claim 10, further comprising the method step of setting a maximum number of pulses (Max NP) set as being equal to the Transition Time (TT) divided by the Pulse Width (PW) plus the minimum transition time (MTT).

12. The illumination control method of claim 11, further comprising the method step of setting a Minimum Frequency (MIF) which is the inverse of the Transition time (TT) and a Maximum Frequency (MXF) which is s inverse of the Pulse Width (PW) plus the result of the Off time (OT) divided by the maximum number of pulses (Max NP).
